(19) United States
(12) Patent Application Publication
(10) Pub. No.: US 2019/0039202 A1
(43) Pub. Date: Feb. 7, 2019

(54) HONING MACHINE WITH MULTIPLE WORKSTATIONS

(71) Applicant: Nagel Maschinen- und Werkzeugfabrik GmbH, Nürtingen (DE)

(72) Inventor: Bernd Nagel, Nürtingen (DE)

(73) Assignee: Nagel Maschinen- und Werkzeugfabrik GmbH, Nürtingen (DE)

(21) Appl. No.: 16/074,534

(22) PCT Filed: Jan. 16, 2017
(86) PCT No.: PCT/EP2017/050782

§ 371 Date: Aug. 1, 2018

(30) Foreign Application Priority Data
Feb. 1, 2016 (DE) 10 2016 201 456.0

(51) Int. Cl. B24B 33/02; B24B 33/10; B24B 33/08; B24B 27/00

(52) U.S. Cl. CPC B24B 33/022; B24B 33/105; B23H 9/08; B24B 27/0023; B24B 33/08

(57) ABSTRACT

A honing machine (100) for carrying out honing operations on boreholes, oriented orthogonally with respect to one another, in a workpiece (102), in particular for honing processing of cylinder boreholes and a bearing gate borehole in a cylinder crank casing, comprises a machine base (110) and a round table (130) which is arranged on the machine base and which can rotate about a vertical round table axis (134) and has a plurality of workpiece receptacles which are arranged offset with respect to one another in a circumferential direction at a radial distance from the round table axis, in such a way that a workpiece which is held in a workpiece receptacle can be transported successively to different workstations (140, 150, 160, 170) of the honing machine by rotating the round table. At least one of the workstations is a vertical honing station (150, 170) which has at least one vertical honing unit (180) which has a honing spindle which can move back and forth in the direction of a spindle axis which is oriented parallel to the round table axis, rotatably about said spindle axis. Furthermore, at least one of the workstations is a horizontal honing station (160) which has at least one horizontal honing unit (300) which has a honing spindle which can move back and forth in the direction of a horizontal spindle axis (304), rotatable about said spindle axis. The horizontal honing unit (300) is or can be positioned with respect to the round table (130) in such a way that the horizontal honing unit assumes a processing position in which the horizontal spindle axis (304) is oriented radially with respect to the round table axis (134).

### FIELD OF APPLICATION AND PRIOR ART

The invention relates to a honing machine for carrying out honing operations on boreholes oriented orthogonally with respect to one another in a workpiece, in particular for honing processing of cylinder boreholes and a bearing gate borehole in a cylinder crank casing.

The cylinder case casing (ZKG), which is often referred to simply as a “crank casing” or “engine block” is an integral component of internal combustion engines or combustion engines such as are used, for example, in passenger cars or trucks, aircraft, ships or stationary installations. The most widespread design is multi-cylinder engines whose pistons are connected by means of connecting rods to the rotating crankshaft, which passes on the force generated by the engine to wheels, ship's screws, propellers, generators or the like.

The cylinder crank casing is an example of a workpiece with boreholes which are oriented orthogonally with respect to one another.

Within the engine block there are a plurality of cylinder boreholes in a straight line one next to the other. In in-line engines or V-engines, the crankshaft is located below the cylinders, and in a boxer engine it is located between the cylinders, and is supported on the cylinder crank casing in the bearing points of the crankshaft bearing borehole. The bearing points are as a rule embodied as sliding bearings, if appropriate also as roller bearings. In order to ensure a high degree of true running of the crankshaft and therefore to minimize undesired wear phenomena and oscillations during operation, the crankshaft must meet high dimensional tolerance requirements. The bearing points must also have narrow tolerances in terms of their size and position in the cylinder crank casing.

The relatively tight tolerances of the decisive parts of an internal combustion engine and of a cylinder crank casing result from the complex functions of these parts. The shape, the dimension and the surface topography of the cylinder borehole determine decisively here the wear, the friction, and consumption of oil and the emission values of the internal combustion engine and, as a result of the wear, also the power and the efficiency. Compressed combustion chamber volume determines overall the compression of the engine. This has effects on the power, and as a result of the combustion profile also influences the emission values and the engine noise.

The precise position of the crankshaft relative to the pistons or to cylinder boreholes is, inter alia, important for reducing the wear on the highly loaded engine parts. These are, in particular, pistons/piston bolts, connecting rods and bearings of the connecting rod on the crankshaft as well as the bearing of the crankshaft in the cylinder crank casing. With respect to the position of the bore axis, not only the absolute position in space but also its angular position or orientation are significant. For example, with manual transmissions with a clutch the crankshaft and the input shaft of the transmission run together. Therefore, a coaxial arrangement of the two shafts is decisive for a long service life.

DE 10 2007 045 619 A1 describes an apparatus for the fine processing of workpieces, preferably for honing and/or fine-drilling cylinder boreholes in the crank casings of internal combustion engines, in which in each case one or two horizontally slideably processing units for honing and/or fine-drilling are provided on two longitudinal sides within a module. Each processing unit has a spindle, a drive for generating the oscillating stroke movement of the spindle and for sliding the processing unit into the processing position, a tool receptacle with rigid axle and a deployment device for radial deploying of the processing tools. Between the longitudinal sides which are equipped with the processing units, a service space which is accessible from an end side is provided, wherein the processing units are assigned at least one tool magazine on the rear end side of the module. An embodiment (FIG. 10) is configured for completely processing the crank casings, for example, for pre-honing of a cylinder borehole and simultaneous processing of the crankshaft borehole. The exemplary embodiment has a horizontal processing unit which is horizontally slideable and which serves to process the borehole sections which are arranged flush with one another and which in the case of a crank casing hold the bearing for the crankshaft.

### Problem and Solution

A problem addressed by the invention is to make available a honing machine with which boreholes which are oriented orthogonally with respect to one another in a workpiece, e.g. cylinder boreholes and a bearing gate borehole in a cylinder crank casing can be processed completely with high precision in a safe process in a short overall processing time by means of honing.

In order to solve this problem, the invention makes available a honing machine having the features of claim 1. Advantageous developments are specified in the dependent claims. The wording of all the claims is incorporated in the contents of the description by reference.

The round table which is arranged on the machine base forms a machine-internal transfer unit with which rapid transfer of the workpieces between the individual workstations can be implemented. By means of the machine-internal round table transfer it is possible to use just a single loading station for loading and unloading the workpiece receptacle. In contrast to transfer machines it is also possible for the workpieces to leave the honing machine at the same location at which they have been fed to the honing machine. This facilitates the loading and unloading and, in particular, also the coupling of the honing machine to an external feed system. By using an external feed system it is possible when necessary for the honing machine to be linked to other honing machines and/or to other processing machines in order to form a production system.

At least one of the workstations is a vertical honing station. The vertical honing station has at least one vertical honing unit whose honing spindle can rotate about a spindle axis which runs parallel to the (vertically oriented) round table axis. This honing spindle can move back and forth in the direction of this vertical spindle axis.

In a vertical honing station, at least one borehole of a first type is therefore processed, which borehole is distinguished by the fact that the borehole axis is oriented vertically or parallel to the round table axis when the workpiece is fixedly held in the assigned workpiece receptacle and is moved into the processing position.

In addition there is provision that at least one of the workstations is a horizontal honing station which has at least one horizontal honing unit which has a honing spindle which can move back and forth in the direction of a horizontal spindle axis, rotatably about said spindle axis. By using the horizontal honing unit it is therefore possible to process at least one borehole of a second type, wherein this borehole is distinguished by the fact that its boring axis is oriented in the horizontal direction, that is to say perpendicularly or orthogonally with respect to boring axes of the first type of borehole. It is therefore possible to use the honing machine to process boreholes which are oriented orthogonally with respect to one another on the workpiece.

The horizontal honing unit is or can be positioned with respect to the round table in such a way that the horizontal honing unit assumes a processing position in which the horizontal spindle axis is oriented radially with respect to the round table axis. The processing position of the horizontal honing unit is that position in which the horizontal honing unit is located in order carry out the processing operations which are provided with it. This arrangement of the horizontal honing unit has, inter alia, advantages with respect to the installation space necessary for the overall arrangement, so that honing machines can be implemented with a more compact overall size.

In one development, the horizontal honing unit is arranged on the machine base which also bears the round table. This permits an arrangement with a high degree of mechanical stability to be implemented in which the spatial relationship between the horizontal honing unit and the round table can be brought about and maintained particularly reliably. In addition, the overall dimensions can be kept compact. It would alternatively also be possible to accommodate the horizontal honing unit on a base which is separate from the machine base and which could then also preferably be fixedly connected to the machine base which bears the round table.

It is possible for the horizontal honing unit to be mounted at a fixed position of the machine base or a base which is separate therefrom, so that the horizontal honing unit is located continuously in its processing position. This results in relatively simple robust variants. According to one development, the horizontal honing unit is, on the other hand, attached to a carriage which can be moved horizontally perpendicularly with respect to the horizontal spindle axis. This can provide increased flexibility during the use of the horizontal honing unit.

In some variants there is provision that the carriage bears, in addition to the horizontal honing unit, at least one further functional unit which can be used within the scope of the processing procedure. The further functional unit can be, for example, a further horizontal honing unit with its own honing spindle. This makes it possible, for example, initially to process a horizontally oriented borehole with a first tool borne by the first horizontal honing unit, and after the conclusion of this processing to move the carriage in such a way that the spindle axis of the other horizontal honing unit is aligned with the boring axis, and then to carry out further honing processing with a second tool by means of the second horizontal honing unit on the same borehole. In this way, for example a pre-honing operation and a finishing honing operation are possible in succession without intermediate reclamping of the workpiece and without changing a tool.

It is also possible for the further functional unit to be a measuring unit, that is to say not to be a processing unit. By using the measuring unit it is possible, for example, for the processing success of a preceding honing operation to be checked and for the further processing to be controlled as a function of the measurement result. It is also possible for the carriage to bear, in addition to the horizontal honing unit, both a further horizontal honing unit and a measuring unit. It is also possible that an independently movable further carriage, which bears the further functional unit, runs on the rails which bear the carriage.

There are different possibilities for the attachment of the at least one vertical honing unit to a load-bearing component of the honing machine.

It has proven favorable if a machine upper part, which is arranged at a vertical distance above the round table, is provided with a fixed spatial relationship to the machine base, wherein the vertical honing unit is borne by the machine upper part. The space between the machine base and the machine upper part can be considered to be a processing space of the honing machine. The attachment of a vertical honing unit to the machine upper part has, in comparison with likewise possible attachment of a vertical honing unit to a more or less vertically oriented sidewall of the honing machine, the advantage that designs are possible which provide the operator with comfortable lateral access to the processing space.

The vertically oriented honing spindle of a vertical honing unit can project downward into the processing space, while some or all of the other components of the honing unit can be arranged outside the processing space, above the machine upper part. By means of the gantry design it is possible to ensure, inter alia, that the lateral access to the processing space in not impeded by components of the honing unit.

In some exemplary embodiments, a plurality of vertical pillars are arranged in the edge region of the machine base, which pillars directly or indirectly bear the machine upper part. It is therefore possible, for example, to configure the machine upper part in such a way that it sits directly on the upper ends of pillars and can be mounted there. It is also possible for pairs of pillars which are laterally offset from one another to each bear a horizontal crossmember onto which the machine upper part is fitted. The arrangement of the machine upper part on pillars can improve the lateral accessibility of the processing space.

In some embodiments a vertical honing unit is attached to a carriage which is borne by the machine upper part. The carriage is preferably arranged on the upper side of the machine upper part, that is to say outside the processing space. The carriage preferably can be moved linearly along a movement direction which is parallel to a vertical plane which contains the round table axis and runs perpendicularly with respect to the horizontal spindle axis of the horizontal honing station. The arrangement can be made here in such a way that the carriage is arranged in such a way that the spindle axes of vertical honing units which are borne by the carriage lie in a vertical plane which contains the round table axis. It is therefore possible for the honing spindle of the vertical honing unit to be moved in a radial direction with respect the round table axis by moving the carriage.

During the processing of the cylinder crank casings, given a suitable arrangement of the cylinder crank casing in a workpiece receptacle of the round table it is possible to successively approach, with a vertical honing spindle, different boreholes of the cylinder crank casing for the purpose of processing. In order to permit this, in some embodiments a workpiece receptacle for holding a cylinder crank casing with a plurality of cylinder boreholes which are arranged in series and have cylinder axes parallel to one another, is formed in such a way that all the cylinder axes lie in a vertical plane containing the round table axis. The axes of the cylinder boreholes therefore lie in a radial direction with respect to the round table axis.

In such an arrangement of a cylinder crank casing it is then possible without further changes of position of the workpiece with respect to the round table to move the cylinder crank casing, by rotating the round table, into a processing position in which the bearing gate borehole can be honed by means of the horizontal honing unit.

In some embodiments it is possible for the orientation of the workpiece held in the workpiece receptacle to be changed relative to the round table when a workpiece is fixedly clamped in it. For this purpose, at least one workpiece receptacle can be embodied as a rotatable workpiece receptacle which can rotate about a workpiece receptacle axis which runs parallel to the round table axis. The workpiece receptacle can therefore be embodied in the manner of a round table on the round table which bears the workpiece receptacle. It would thereby also be possible, for example during the processing of cylinder cranks casings, to orient the workpiece for the processing of the bearing gate borehole in such a way that it runs radially with respect to the round table axis, and to orient the workpiece for the processing of a series of cylinder boreholes by means of a 90° rotation in such a way that all the cylinder axes lie in a common tangential plane on a reference circle which is coaxial with respect to the round table axis.

The number of usable vertical honing units can be adapted to the processing task. In many variants at least one vertical honing station has two or more vertical honing units which can operate simultaneously, wherein, preferably two vertical honing stations are provided with two honing units each.

Some embodiments are configured for an automatic tool change in order to be able to equip honing units (vertical honing units and/or horizontal honing unit) promptly with different honing tools if a tool change should be necessary, for example when a honing tool experiences wear or else in the case of a changeover between different honing operations. For this purpose, some embodiments have at least one tool change device with a tool magazine which can hold a plurality of honing tools.

It is possible e.g. that a tool change device is arranged in the processing region of a linearly movable carriage in such a way that the honing unit which is borne by the carriage (vertical honing unit or horizontal honing unit) can be moved, for a tool change, between the honing station and the tool change device. It is also possible to equip a tool change device with a movable grip for transportation of a tool between a tool magazine and a honing spindle.

### BRIEF DESCRIPTION OF THE DRAWINGS

Further advantages and aspects of the invention emerge from the claims and from the following description of preferred exemplary embodiments of the invention which are explained in more detail below with reference to the figures.

FIG. 1 shows an oblique perspective view of a honing machine according to an exemplary embodiment of the invention;

FIG. 2 shows a plan view of the honing machine from FIG. 1;

FIG. 3 shows a side view of the longitudinal side of the honing machine from FIG. 1;

FIG. 4 shows a front view of the honing machine from that side on which the loading and unloading of the honing machine takes place;

FIG. 5 shows a plan view of an embodiment of a honing machine with an automatic tool changer for honing tools of the horizontal honing unit; and

FIG. 6 shows a side view of an embodiment of a honing machine in which horizontally movable vertical honing units are mounted laterally on the machine upper part.

### DETAILED DESCRIPTION OF EXEMPLARY EMBODIMENTS

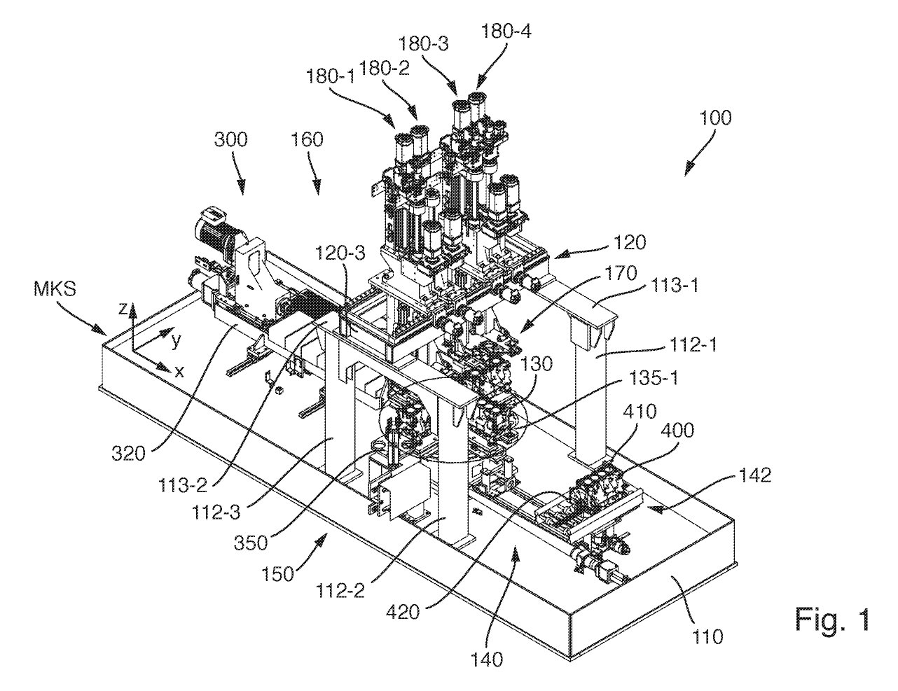

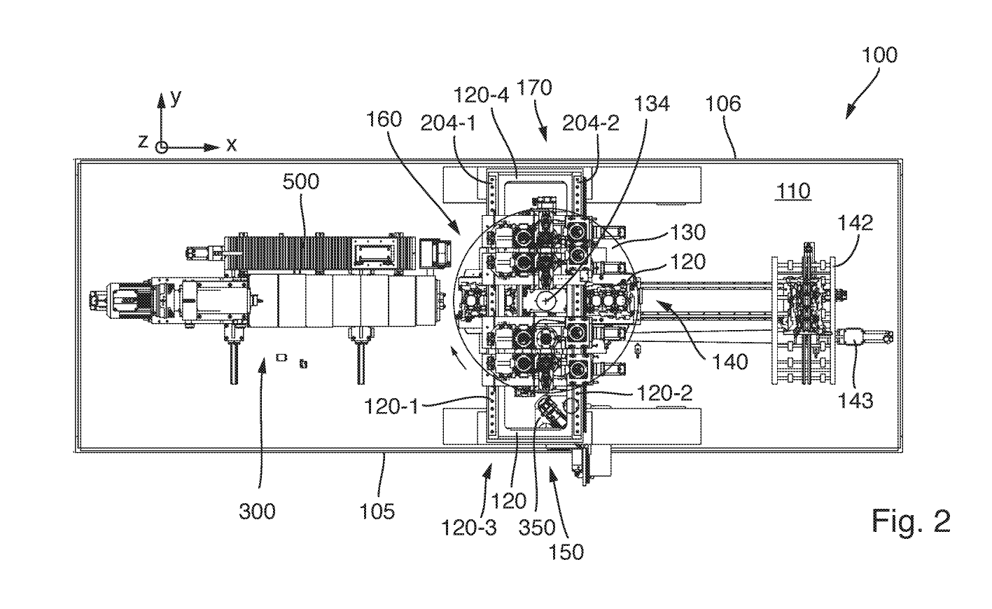

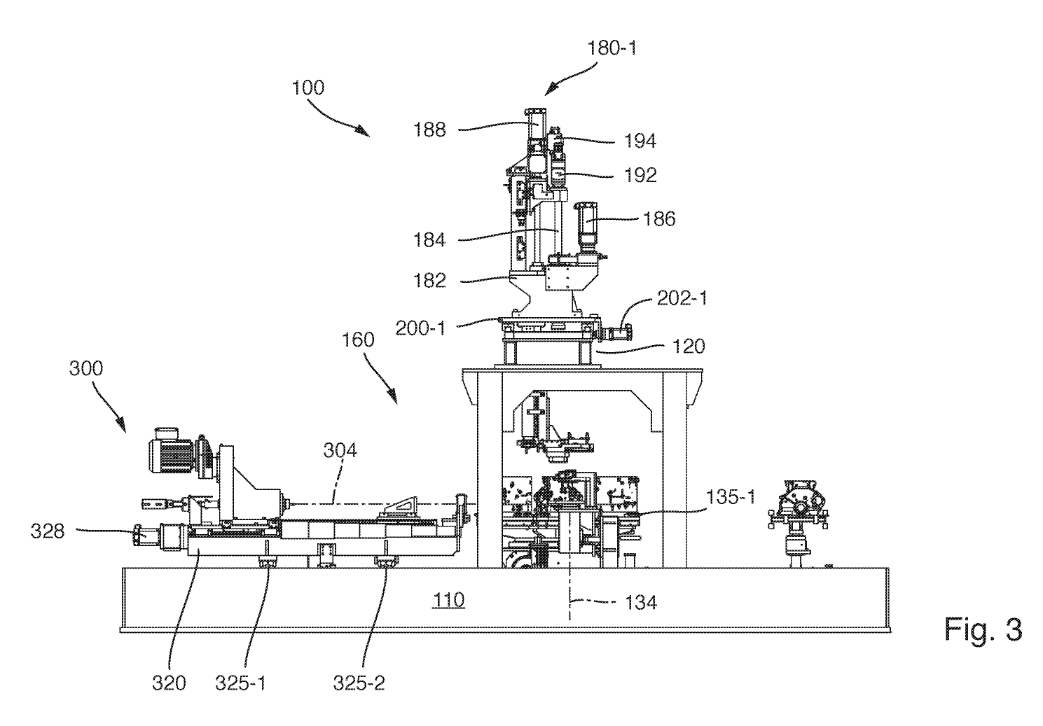

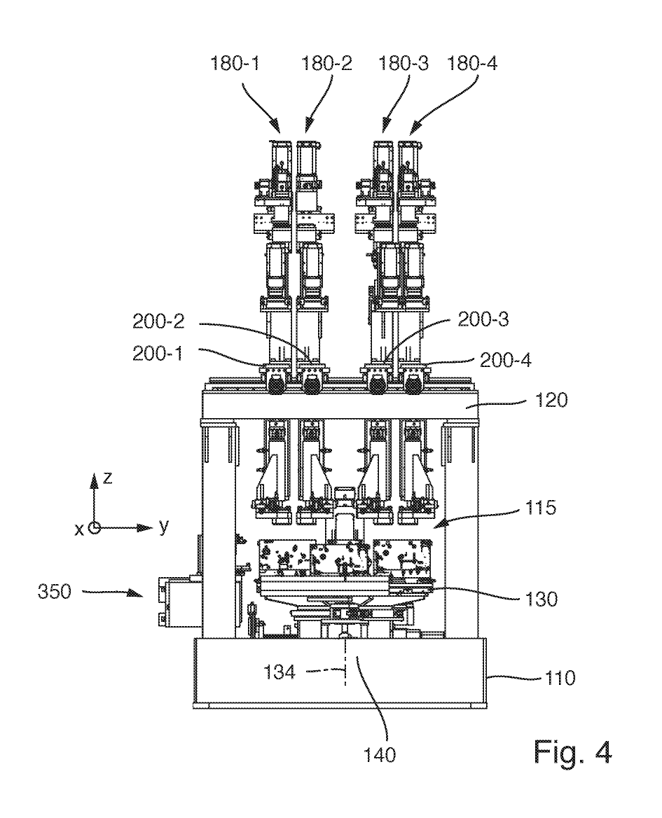

FIG. 1 shows an oblique perspective view of a honing machine 100 according to an exemplary embodiment of the invention. FIG. 2 shows a plan view of the honing machine. FIG. 3 shows a side view of the longitudinal side and FIG. 4 shows a front view of that side on which the loading and unloading of the honing machine takes place. The honing machine 100 is configured to carry out honing operations, at workpieces with boreholes which are oriented orthogonally with respect to one another, on boreholes with different orientations. In the exemplary case, the honing machine is configured to process, by means of honing, both the cylinder boreholes 410 and the bearing gate borehole 420 (crankshaft borehole), oriented perpendicularly with respect to the cylinder boreholes, on workpieces 400 in the form of cylinder crank casings (engine blocks).

The honing machine 100 has a machine base 110 which is rectangular in plan view and which bears all the mechanical components of the honing machine. The width of the machine base which is measured in the y-direction (transverse direction) of the machine coordinate system MKS is 1700 mm in the exemplary case, and is typically between 1500 mm and 2500 mm. The length measured in the x-direction (longitudinal direction) is 6500 mm. The narrow design permits transportation of the completely pre-mounted machine base on customary transportation means, for example by means of a truck or a rail vehicle.

A round table 130, which is rotatable to an unlimited degree about a vertical round table axis 134 by means of a rotary drive which is arranged under the round table is mounted on the machine base, approximately in the central third when viewed in the longitudinal direction. Four workpiece receptacles 135-1 to 135-4 are arranged at equal angular intervals of 90° with respect to one another on the upper side of the round table and are attached at equal radial distances from the round table axis. Each of the workpiece receptacles has support faces, indexing elements and pneumatic support controllers and serves to hold an individual cylinder crank casing which is clamped fixedly into the workpiece receptacle. The cylinder crank casing is oriented here in such a way that the cylinder axes, parallel to one another, of the cylinder boreholes which are arranged in series lie in a common vertical plane which contains the round table axis. The series of cylinder boreholes is therefore oriented in a radial direction with respect to the round table axis. In the case of embodiments for holding the cylinder crank casings for V-type engines a workpiece receptacle also has a pivoting device.

The round table serves as a machine-internal transfer system in such a way that a workpiece which is held in a workpiece receptacle can be transported successively to different workstations of the honing machine by rotating the round table.

Using the honing machine it is possible, with the selected division of the round table with four workpiece receptacles, to move workpieces to a total of four workstations simultaneously. The loading station 140 whose devices are provided for transporting in each case one workpiece to an empty workpiece receptacle on the round table and/or for transporting a workpiece to be unloaded out of a workpiece receptacle is provided centrally on the narrow front side which can be seen in FIG. 4. For this purpose, in the exemplary case a horizontally movable swinging carriage 142 is provided which is guided on rails which run in the x-direction and which are mounted on the machine base 110. The swinging carriage which is driven by means of a separate drive 143 can in this way be moved to and fro between an inner end position in the region of a workpiece receptacle and an outer end position (shown in the figures).

As is apparent in FIG. 2, both the inner end position (in the vicinity of the round table) and the outer end position (further away from the round table) are accessible from above, so that loading and unloading of the swinging carriage is possible from above, for example by means of a gantry gripper.

By rotation of the round table through 90° in the clockwise direction it is possible initially to transport a held workpiece starting from the loading station 140 initially into a processing position at a first vertical honing station 150. The latter is located on a first longitudinal side 105 of the honing machine. A further rotation through 90° moves the workpiece to a horizontal honing station 160 which is located centrally between the longitudinal sides of the machine base. A further rotation by 90° moves a workpiece into a processing position in the region of a second vertical honing station 170 which is located on the second longitudinal side 106 lying opposite the first longitudinal side. A further 90° rotation then moves the workpiece back again into the region of the loading station 140.

Each of the two vertical honing stations 150, 170 is equipped with two vertical honing units 180-1 to 180-4 which are of essentially identical design and can be operated independently of one another with staggered timing or simultaneously. Each of the vertical honing units has an individual honing spindle which can be moved rotatably about a vertical spindle axis oriented parallel to the round table axis by means of a rotary drive, and to and fro parallel to the spindle axis by means of a reciprocating drive. A vertical honing unit also comprises a deployment system for radially deploying or for radially retracting honing elements which are arranged on the circumference of a honing tool which is borne by the honing spindle.

The design of a vertical honing unit will be explained in more detail using the example of the vertical honing unit 180-1 (shown in FIG. 3). The vertical honing unit 180-1 comprises a spindle box 182, which serves as a bearing for the honing spindle 184 which is guided with the vertical spindle axis in the spindle box. The rotation of the honing spindle about the spindle axis is brought about by a rotary drive 186 which acts on the honing spindle. A reciprocating drive 188 brings about the vertical movements of the honing spindle, running parallel to the spindle axis, when the honing tool is inserted into the borehole to be processed or when the honing tool is pulled out of this borehole. Furthermore, the reciprocating drive can be actuated during the honing processing in such a way that the honing tool executes a vertical to and fro movement corresponding to the desired honing parameter, within the borehole of the workpiece.

The vertical honing unit has a deployment system which comprises deployment devices which can be activated independently of one another, in order, where appropriate, to be able to actuate honing tools with double expansion. A first deployment device has a first expansion drive 192 with a servomotor which acts on a pressure rod which runs centrally through the honing spindle and can displace said pressure rod axially. This pressure rod is arranged within a hollow pressure rod, coaxially with respect to the latter and movably relative thereto. The hollow pressure rod forms part of an electromechanical second deployment device with an electromechanical deployment drive 194. Since the design of double-expanding deployment systems is known per se, a detailed description is not given here.

All the vertical honing units are borne by a machine upper part 120 which is arranged at a vertical distance above the round table 130 and engages over the round table in the transverse direction, that is to say parallel to the y-axis. Four vertical pillars 112-1 to 112-3, which are attached to the upper side of the machine base by means of screws, serve to the bear the machine upper part 120. The pillars are arranged in the corner regions of a rectangle in which the round table axis 134 lies, so that the round table is arranged at least mainly within the space bounded by the pillars. In each case two pillars which are arranged on a common longitudinal side bear one crossmember 113-1, 113-2 which is attached to the upper ends of said pillars and which runs parallel to the longitudinal side (i.e. in the x-direction). The crossmembers which are parallel to one another bear the horizontally oriented machine upper part 120 which extends between the crossmembers in the y-direction. The machine upper part is in the shape of a rectangular frame with two bar-like frame elements 120-1, 120-2 which are parallel to one another and run at a distance from one another in the transverse direction from crossmember to crossmember and are connected at the crossmembers by means of relatively short frame elements 120-3, 120-4 which run in the longitudinal direction.

The space which is bounded by the pillars and the machine upper part can be referred to as a processing space 115 of the honing machine. The width, measured in the x-direction (longitudinal direction), of the machine upper part is less than half the distance, measured in the x-direction, between the pillars bearing a crossmember. The machine upper part is not located centrally above the round table but rather is set back toward the rear with respect to the loading station 140, so that the workpiece receptacle which is respectively located on the loading station 140 is accessible from above for loading and unloading (cf. FIG. 2).

Each of the vertical honing units 180-1 to 180-4 which is associated with a vertical honing station is respectively mounted on a carriage 200-1, 200-2, 200-3, 200-4, which is borne by the machine upper part 120. The four carriages each run on a pair of guide rails 204-1, 204-2 which run at a lateral distance from one another in the transverse direction on the upper side, facing away from the processing space, of the machine upper part, on the frame elements 120-1, 120-2 running in the transverse direction. The rectangular frame of the machine upper part encloses a cutout through which the honing spindle or a drive rod attached thereto are guided downward into the processing space.

Associated with each carrier is a dedicated servomotor (e.g. 202-1) so that the carriages can be moved independently of one another in the transverse direction (y-direction). The spindle axes of the vertical honing units each lie here in a vertical plane which contains the round table axis 134 and runs in the y-direction or perpendicularly with respect to the x-direction. Since the cylinder boreholes of a held cylinder crank casing are also arranged in rows in the radial direction with respect to the round table axis, owing to this arrangement it is possible firstly, without displacing the workpiece, to process a first borehole on a workpiece, then to retract the honing spindle, move the vertical honing unit in its entirety in a transverse movement parallel to the y-direction, and position it coaxially with respect to a second borehole which is to be subsequently processed, in order to process the second borehole with the same vertical honing unit.

In order to permit complete processing of cylinder crank casings by means of honing without reclamping the workpiece, the honing machine has, in addition to the two vertical honing stations (with two vertical honing units each), also a horizontal honing station 160. Associated with the latter is a horizontal honing unit 300 which has a honing spindle which can rotate about a horizontal spindle axis and can move to and fro in the direction of the spindle axis. In FIGS. 1 to 3, the horizontal honing unit is illustrated in its processing position which is distinguished by the fact that the horizontal spindle axis 304 of the horizontal honing spindle is oriented radially with respect to the round table axis 134. With the orientation of the cylinder crank casing which is described above, with axes of the cylinder boreholes lying in a radial plane, the bearing gate borehole 420 or crankshaft borehole is oriented in such a way that its longitudinal axis runs radially with respect to the round table axis. The bearing gate borehole can therefore be processed using the horizontal honing unit if a cylinder crank casing has been rotated, by rotating the round table into the processing position which is associated with the horizontal honing station 160.

One particular feature of this concept is that simultaneous processing of cylinder boreholes and of the crankshaft borehole is neither desired nor possible. Rather, the arrangement ensures that only one or more cylinder boreholes or the bearing gate borehole are processed on each workpiece. Compared to simultaneous processing of cylinder boreholes and the bearing gate borehole this results, inter alia, in the advantage of relatively high processing reliability and relatively high quality of the processed boreholes, since processing residues (e.g. swarf) of the one processing operation (for example processing of the cylinder borehole) cannot adversely affect the processing of the other borehole (bearing gate borehole). Instead, as a result of the chronologically successive processing of the boreholes which run orthogonally with respect to one another and, if appropriate, as a result of an intermediate cleaning step (e.g. by rinsing and/or by means of compressed air) it can be ensured that no processing residues of a processing procedure can adversely affect the other processing procedure. Owing to the round table transfer, short overall processing times are nevertheless achievable for the honing processing of a cylinder borehole and bearing gate borehole.

In the exemplary embodiment shown, the horizontal honing unit is mounted on a carriage 320 which can be moved perpendicularly with respect to the horizontal spindle axis 304 in the transverse direction of the honing machine, i.e. parallel to the y-direction of the machine coordinate system. For this purpose, two guide rails 325-1, 325-2 which are parallel to one another and on which the carriage 320 runs are mounted on the machine bed. A servomotor 328, which is mounted on the carriage, serves to drive the displacement movement which proceeds transversely.

The carriage also bears a measuring unit 500 for measuring the bearing gate borehole before and/or after the honing processing. The measuring unit has a measuring spindle which can be moved axially and parallel to the horizontal spindle axis 304 and which bears at its free end a measuring head which can be introduced into the bearing gate borehole.

Possible ways of configuring the horizontal honing unit and possibilities for suitable honing tools for processing the bearing gate borehole and for suitable tool guiding means can be similar or identical to those solutions which are described in DE 10 2011 079 900 A1 of the applicant. The disclosure content of this document is in this respect incorporated in the content of the present description by reference.

Possibilities for loading and unloading a pendulum carriage, which can be used for loading and unloading a round table of a honing machine, are for example described in WO 2013/117482 A1. This document furthermore specifies alternatives to equipping by means of pendulum carriages which can be used in the same manner or with modifications in honing machines of the present application as well. The disclosure content of WO 2013/117482 A1 in this respect is incorporated into the content of this description by reference.

In order to increase the productivity, devices for an automatic tool change can be provided both for the vertical honing units and for the horizontal honing unit. In the embodiment of FIGS. 1 to 4, the vertical honing units 180-1 and 180-2 are assigned a tool change device 350 which has a rotatable tool magazine with a plurality of receptacle places for tools. The tools in the magazine are located in the movement region of the two vertical honing units 180-1, 180-2 which are arranged on the same side, so that a vertical honing unit for a tool change can be moved into the region of the tool magazine. On the other longitudinal side, a second corresponding tool magazine is arranged which is assigned to the two other vertical honing units 180-3, 180-4. If the movement travel of the vertical honing units in the Y-direction is not sufficient to achieve positioning over a tool magazine, the tool magazine can additionally be moved counter to the vertical honing units in the Y-direction. The tool magazines for the vertical honing units also have for this purpose a translatory axis in the Y-direction in addition to a rotational axis.

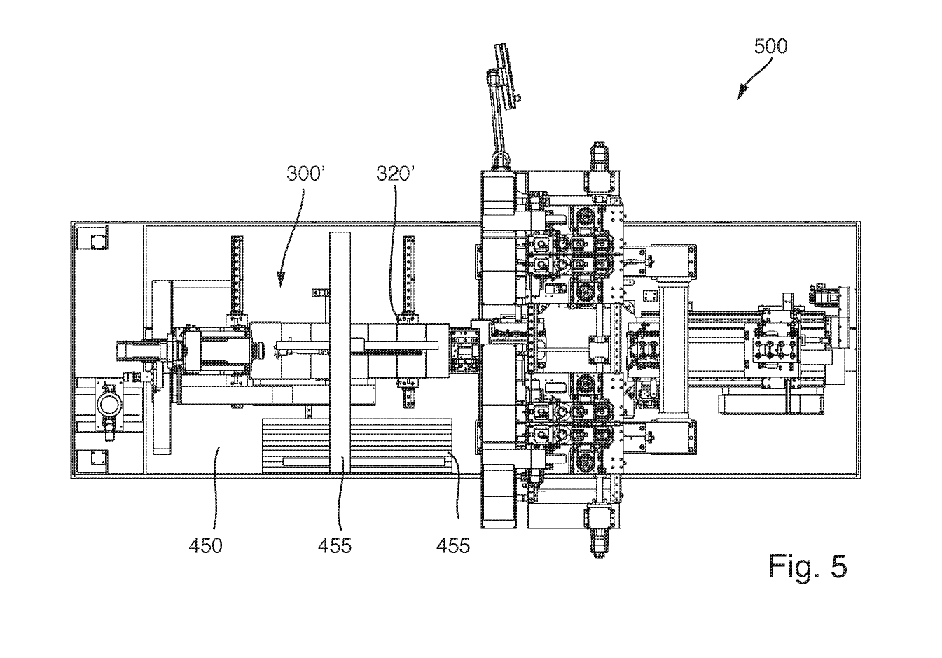

FIG. 5 shows a plan view of an exemplary embodiment of a honing machine 500. In the honing machine 500, the horizontal honing unit 300′ is assigned a tool change device 450. The latter comprises a tool magazine 455 which is arranged on the machine bed, in addition to the guide rails for the carriage 320′. Running above the tool magazine and the horizontal honing unit in the transverse direction is a guide rail 455 which bears a tool gripper (not illustrated). For the tool change, firstly a honing tool which is to be exchanged is gripped, decoupled from the honing unit and stored in the tool magazine, and after this the new honing tool is gripped and moved into the coupling position where it is coupled to a honing spindle.

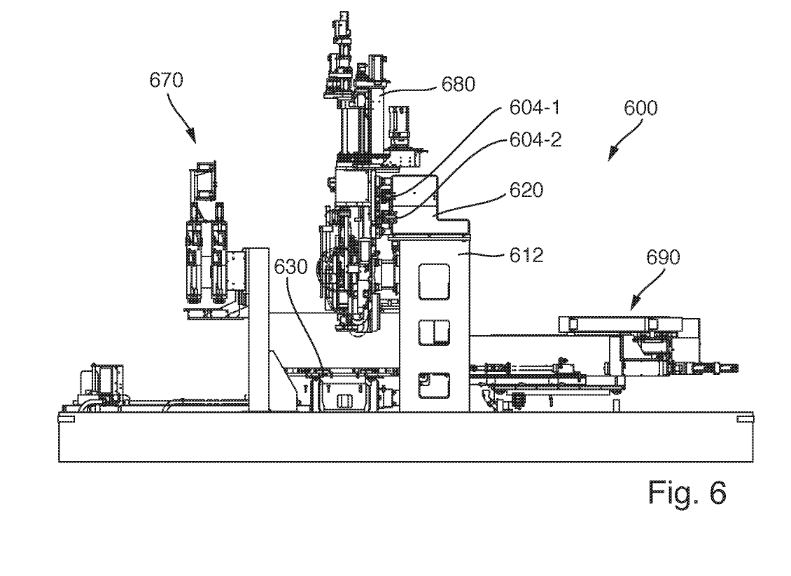

In the exemplary embodiments in FIGS. 1 to 5, the carriages which bear the horizontally movable vertical honing units are mounted on the upper side of the machine upper part. However, this is not compulsory. In the exemplary embodiment of the honing machine 600 in FIG. 6 there is a machine upper part 620 which is arranged at a vertical distance above the round table 630 and engages over the round table in the transverse direction (parallel to the y-axis). The solid machine upper part is borne on both sides of the round table by stable vertical pillars 612. Horizontal guide rails 604-1, 604-2 are mounted on the side of the machine upper part 620 facing away from the horizontal honing unit 690, which guide rails 604-1, 604-2 bear four carriages which can move horizontally independently of one another, wherein each carriage bears one of the vertical honing units 680.

Furthermore, a measuring unit 670 which bears two measuring spindles which are provided for measuring the honed cylinder boreholes is arranged on the side of the round table 630 lying opposite the horizontal honing unit.

1. A honing machine for carrying out honing operations on boreholes oriented orthogonally with respect to one another in a workpiece, in particular for honing processing of cylinder boreholes and a bearing gate borehole in a cylinder crank casing, having:
a machine base;
a round table which is arranged on the machine base and which can rotate about a vertical round table axis and has a plurality of workpiece receptacles which are arranged offset with respect to one another in a circumferential direction at a radial distance from the round table axis, in such a way that a workpiece which is held in a workpiece receptacle can be transported successively to different work stations of the honing machine by rotating the round table; wherein
at least one of the workstations is a vertical honing station which has at least one vertical honing unit which has a honing spindle which can move back and forth in the direction of a spindle axis, which is oriented parallel to the round table axis, rotatably about said spindle axis; and
at least one of the workstations is a horizontal honing station which has at least one horizontal honing unit which has a honing spindle which can move back and forth in the direction of a horizontal spindle axis, rotatably about said spindle axis,
wherein the horizontal honing unit is or can be positioned with respect to the round table in such a way that the horizontal honing unit assumes a processing position in which the horizontal spindle axis is oriented radially with respect to the round table axis.

2. The honing machine as claimed in claim 1, wherein the horizontal honing unit is arranged on the machine base.

3. The honing machine as claimed in claim 1, wherein the horizontal honing unit is attached to a carriage which can be moved horizontally perpendicular with respect to the horizontal spindle axis.

4. The honing machine as claimed in claim 3, wherein the carriage bears at least one further functional unit which is preferably a further horizontal honing unit or a measuring unit.

5. The honing machine as claimed in claim 1, characterized by a machine upper part which is arranged at a distance above the round table, wherein the vertical honing unit is borne by the machine upper part.

6. The honing machine as claimed in claim 5, characterized by a plurality of vertical pillars which are arranged in the edge region of the machine base and bear the machine upper part.

7. The honing machine as claimed in claim 5, wherein the vertical honing unit is attached to a carriage which is borne by the machine upper part, wherein the carriage is preferably arranged on the upper side of the machine upper part.

8. The honing machine as claimed in claim 7, wherein the carriage can be moved along a movement direction which is parallel to a vertical plane which contains the round table axis and runs perpendicularly with respect to the horizontal spindle axis of the horizontal honing unit.

9. The honing machine as claimed in claim 7, wherein the carriage is arranged in such a way that the spindle axis of a vertical honing unit which is borne by the carriage lies in the vertical plane.

10. The honing machine as claimed in claim 8, wherein a workpiece receptacle for holding a cylinder crank casing is formed with a plurality of cylinder boreholes which are arranged in series and have cylinder axes parallel to one another, in such a way that all the cylinder axes lie in the vertical plane containing the round table axis.

11. The honing machine as claimed in claim 1, wherein at least one vertical honing station has two or more vertical honing units which can operate simultaneously, wherein two vertical honing stations are preferably provided with two vertical honing units each.

12. The honing machine as claimed in claim 1, wherein it is configured for an automatic tool change and has at least one tool changing device with a tool magazine which can hold a plurality of honing tools.
